(19) United States
(12) Patent Application Publication
(10) Pub. No.: US 2011/0066468 A1
(43) Pub. Date: Mar. 17, 2011

(54) DYNAMIC EVENT PLANNING THROUGH LOCATION AWARENESS

(75) Inventors: Yunwu Huang, Chappaqua, NY (US); Yue Zhang, Pittsburgh, PA (US)

(73) Assignee: INTERNATIONL BUSINESS MACHINES CORPORATION, Armonk, NY (US)

(21) Appl. No.: 12/558,089

(22) Filed: Sep. 11, 2009

(51) Int. Cl. G06Q 10/00; G01C 21/00

(52) U.S. Cl. 705/9; 701/300; 701/204

(57) ABSTRACT

Discloses a computer-implemented apparatus for dynamic event planning for a plurality of attendees. Included is an event scheduler to schedule, update and delete events for the plurality of attendees, an event location finder invoked by the event scheduler to select at least one event location having an available timeslot for an event for the plurality of attendees, a transition requirement monitor invoked by the event scheduler to estimate a transition time from an origin location to the event location to determine if the available timeslot is feasible for the event, and a dynamic location tracker to track a location of the plurality of attendees and generate an event exception notice for the plurality of attendees if at least one attendee will be unable to attend the event at the event location at the available timeslot. Also disclosed is a computer-implemented method for dynamic event planning for a plurality of attendees and a computer program product for dynamic event planning for a plurality of attendees.

### BACKGROUND OF THE INVENTION

The present invention relates to scheduling of events for multiple attendees and more particularly to scheduling systems which schedule events while taking into account the location of the attendees and the transition time to attend the event.

Meetings occupy a large part of the day for many people. Scheduling systems, and particularly electronic calendaring systems, offer automated features that assist users to better track and manage calendar events. More advanced electronic calendaring systems provide advanced features such as allowing users to send meeting requests to other users through email. Recipients of meeting requests may response to the sender or counter propose another meeting time. A positive response to a meeting request creates a corresponding meeting event on the calendar of the responder. The meeting organizer may also use these systems to inspect the calendar of the attendees in order to search for common open time slots.

Electronic calendaring has become more than just an event tracking application; it is an essential tool for collaboration.

The electronic calendar system of a mobile device is particularly useful because the user can schedule, update or be notified of events at any time and any place, without being restricted to fixed spots. Furthermore, mobile devices travel with the users, hence can be used to track the users' location.

### BRIEF SUMMARY OF THE INVENTION

The various advantages and purposes of the present invention as described above and hereafter are achieved by providing, according to a first aspect of the invention, a computer-implemented apparatus for dynamic event planning for a plurality of attendees including an event location finder to select at least one event location having an available timeslot for an event for the plurality of attendees; a transition requirement monitor to estimate a transition time from an origin location to the event location to determine if the available timeslot is feasible for the event; and a dynamic location tracker to track a location of the plurality of attendees and provide an event exception notice to the plurality of attendees if at least one attendee will be unable or late to attend the event at the event location at the available timeslot.

According to a second aspect of the invention, there is provided a computer-implemented apparatus for dynamic event planning for a plurality of attendees including an event scheduler to schedule, update and delete events for the plurality of attendees; an event location finder invoked by the event scheduler to select at least one event location having an available timeslot for an event for the plurality of attendees; a transition requirement monitor invoked by the event scheduler to estimate a transition time from an origin location to the event location to determine if the available timeslot is feasible for the event; and a dynamic location tracker to track a location of the plurality of attendees and generate an event exception notice for the plurality of attendees if at least one attendee will be unable or late to attend the event at the event location at the available timeslot.

According to a third aspect of the invention, there is provided a computer-implemented method for dynamic event planning for a plurality of attendees, the method including the steps of selecting at least one event location having an available timeslot for an event for the plurality of attendees; estimating a transition time from an origin location to the event location to determine if the available timeslot is feasible for the event; and dynamically tracking a current location of the plurality of attendees and providing an event exception notice to the plurality of attendees if at least one attendee will be unable or late to attend the event at the event location at the available timeslot.

According to a fourth aspect of the invention, there is provided a computer-implemented method for dynamic event planning for a plurality of attendees including obtaining an event scheduler to schedule, update and delete events for the plurality of attendees; invoking an event location finder by the event scheduler to select at least one event location having an available timeslot for an event for the plurality of attendees; invoking a transition requirement monitor by the event scheduler to estimate the transition time from an origin location to the event location to determine if the available timeslot is feasible for the event; and dynamically tracking a current location of the plurality of attendees and generating an event exception notice for the plurality of attendees if at least one attendee will be unable or late to attend the event at the event location at the available timeslot.

According to a fifth aspect of the invention, there is provided a computer program product for dynamic event planning for a plurality of attendees, the computer program product including a computer readable storage medium having computer readable program code embodied therewith, the computer readable program code including computer readable program code configured to select at least one event location having an available timeslot for an event for the plurality of attendees; computer readable program code configured to estimate a transition time from an origin location to the event location to determine if the available timeslot is feasible for the event; and computer readable program code configured to dynamically track a current location of the plurality of attendees and provide an event exception notice to the plurality of attendees if at least one attendee will be unable or late to attend the event at the event location at the available timeslot.

### BRIEF DESCRIPTION OF THE DRAWINGS

The features of the invention believed to be novel and the elements characteristic of the invention are set forth with particularity in the appended claims. The Figures are for illustration purposes only and are not drawn to scale. The invention itself, however, both as to organization and method of operation, may best be understood by reference to the detailed description which follows taken in conjunction with the accompanying drawings in which:

FIG. 1 is a block diagram of the architecture for the dynamic event planning apparatus according to the present invention.

FIG. 2 is a flowchart of an exemplary computer-implemented method for practicing the present invention.

FIG. 3 is a block diagram for an exemplary hardware environment for practicing the present invention.

### DETAILED DESCRIPTION OF THE INVENTION

The core content of any calendar system is the events. A calendar event by definition is temporal in nature, with attributes including starting time and duration. An event may also carry attributes such as attendees, commonly modeled by email addresses used for the request/response communication. Intuitively, an event may be associated with a location, or venue, commonly modeled as text data such as the room/building identifier or postal address. In an electronic calendaring system, locations such as conference rooms and their availability are managed by the system as resources that can be searched and attached to events.

While an event is temporal in nature, its associated entities such as attendees and location have a spatial context. For example, a meeting location such as a conference room can have properties including a textual room/building identifier or postal address; it can also be identified by its global geographic coordinates (geocode). A meeting can be attended virtually such as a conference based on phone, Internet, or virtual worlds, or their combinations. Many events involve both physical and virtual attendees. But in the scope of the present invention, events are considered that require the scheduling of an actual venue with the physical presence of at least one attendee. More precisely, the term attendee means attendee with physical attendance.

A meeting attendee can also be associated with spatial properties. For example, the spatial properties of an event attendee may include the spatial information of her home, her office, and the geocode of her current location. The current geocode of an attendee is obtainable if she carries a mobile device equipped with the Global Positioning System (GPS). Whereas the geocode of a meeting room is static, those of an attendee change dynamically. To make sure the spatial property of an attendee is up-to-date, a system needs to be in place to track and update the geocode of attendees.

The present inventors believe that spatial information can be integrated into the calendar application to make event planning more intelligent. Thus, spatial information can help users schedule, keep track, and cope with dynamic changes more efficiently. The present inventors have built a location aware event planning calendar system called ePLAN (event Planner with Location AwareNess). ePLAN is an apparatus for dynamic event planning for a plurality of attendees. While ePLAN offers general event planning functions such as scheduling, updating and deleting events, the main goal of ePLAN is to integrate location awareness into event planning and explore innovative approaches to make event planning more intelligent and productive.

There are several features of ePLAN that use spatial data of event attendees and locations to automate the event planning process for better productivity. Among the features of ePLAN are:
1) Event location finder uses spatial and temporal information to help select a most desirable event location and time combination. It is based on the optimization of overall estimated transition cost that is modeled using different metrics including geocode-based distance, estimated travel time and mileage extracted from Web-based map direction services.
2) Transition Requirement monitor uses both spatial and temporal information to estimate transition time going into an event. Such information can be used to more accurately model the availability of a schedule, as well as prevent scheduling errors caused by insufficient transition time to an event.
3) Dynamic location tracker uses real-time spatial information of attendees to detect and notify exceptions such as late arrival, inability to attend, and wrong event venue.

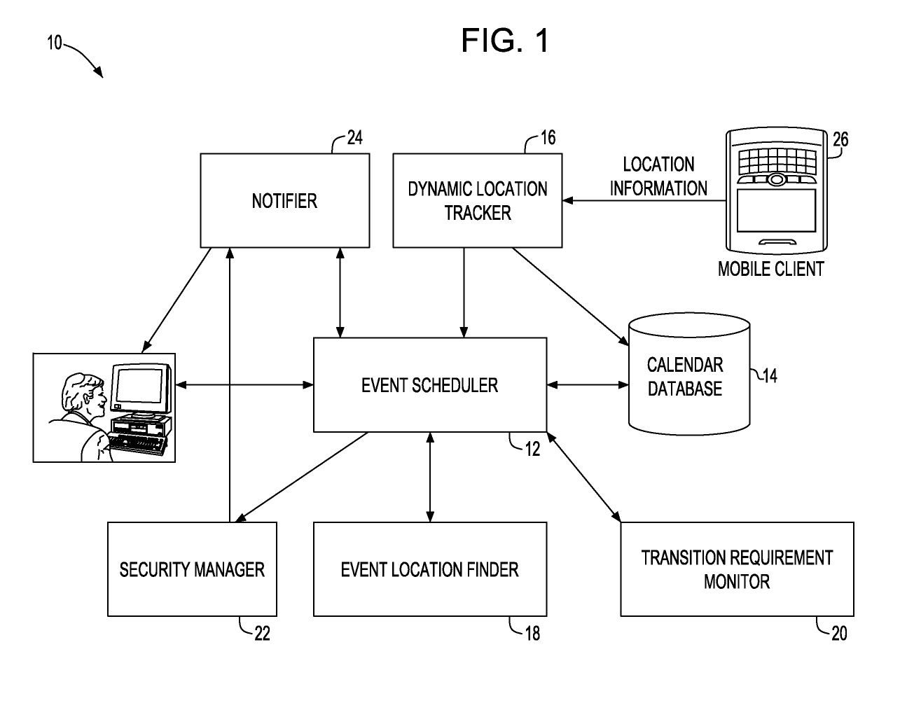

Referring now to the Figures in more detail, and particularly referring to FIG. 1, the ePLAN architecture according to the present invention is shown. As depicted in FIG. 1, the architecture of ePLAN 10 includes an event scheduler 12, a calendar database 14, a dynamic location tracker 16, an event location finder 18, a transition requirement monitor 20, a security manager 22 and notifier 24. Location information for each attendee may be fed to the dynamic location tracker 16 by a suitable geocode generating device (also known as a mobile client) 26 such as a personal digital assistant (PDA) having GPS capability. Each of the foregoing components of ePLAN 10 is now described in more detail.

### The Event Scheduler

The Event Scheduler 12 of ePLAN 10 is responsible for interacting with the user for the scheduling, updating and deletion of events, invoking the Event Location Finder 18 to find the most desirable location and time combination for an event and invoking the Transition Requirement Monitor 20 to ensure feasible transition time between events. The Event Scheduler 12 receives event exception notices from Dynamic Location Tracker 16. Upon receiving an event exception notice indicating, for example, that a user will be late or unable to attend or that the event location is incorrect, the Event Scheduler 12 invokes Notifier 24 to send notification to the attendees of the exception event. The Event Scheduler 12 may dynamically reschedule an event for a certain user if Dynamic Location Tracker 16 sends out an event exception notice and determines, for example, that this user will not be able to attend the originally scheduled event.

### The Calendar Database

The Calendar Database 14 is the repository of all digital artifacts such as the events and venue data. The spatial information such as geocode associated with event venues and attendees are also stored in Calendar Database 14.

### The Dynamic Location Tracker

The Dynamic Location Tracker 16 keeps track of the current location of attendees during some periods of time. If Dynamic Location Tracker 16 determines that the current location of an attendee causes an exception, e.g., late arrival or no show for the next meeting, it sends the exception to Event Scheduler 12 for potential rescheduling of this event, and to Notifier 24 to send notification to other attendees based on a configuration managed by Security Manager 22.

### The Notifier

The Notifier 24 receives requests from Event Scheduler 12 to send event exception notices to attendees. The content of the event exception notice is generated by Dynamic Location Tracker 16 whereas the list of target attendees is provided by Event Scheduler 12. The actual technology used for transporting the exception notices is implementation specific. Examples of notification technology, for purposes of illustration and not limitation, include SMS (Short Message Service), automated voice messages, email, or their combinations.

### The Security Manager

The Security Manager 22 manages the privacy profile of a user to protect the privacy of the users. By configuring the privacy profile, users specify their own privacy requirements through rules. In particular, each user is able to specify when her dynamic location can be disclosed (e.g. only during work time), where her location can be disclosed (e.g. only in the company area), and to whom her location can be disclosed (e.g. only to the server, not to any other users).

### The Event Location Finder

The Event Location Finder 18 is invoked by Event Scheduler 12 on behalf of a user during the event scheduling and rescheduling processes. It searches the Calendar Database 14 for an event location with an open time slot such that the combination is most desirable based on transition cost measurement specified by the user. How transition cost is defined can depend on company policy and user preference.

### The Transition Requirement Monitor

The Transition Requirement Monitor 20 is also invoked by Event Scheduler 12 on behalf of a user during the event scheduling and rescheduling processes. It checks to see if a time slot is feasible for a given event and considers factors such as the origin location of the user and the temporal and spatial distances from the previous event to the next event or from the current event to the next event. The Transition Requirement Monitor 20 estimates the transition time used to more accurately model the availability of a schedule. The estimated transition time can also be used to prevent scheduling errors caused by insufficient transition time. As an example, a user's location at the start of the day may be the home of the user which is the origin location. The Transition Requirement Monitor 20 would estimate the transition time from the origin location to the location of a scheduled event. During the transition from the origin location to the scheduled event, the Dynamic Location Tracker 16 keeps track of the user's current location. At the start of the day, the user's current location may be the origin location. When considering the transition time from the scheduled event to the next scheduled event, the user's location at the scheduled event becomes the origin location.

### The Mobile Client

The Mobile Client 26 is a lightweight application on a mobile device such as a PDA, for example a BlackBerry. Its main task is to report the current location of the mobile user to Dynamic Location Tracker 16. The Mobile Client 26 reports its current location by requesting the on-device GPS service for the current geocode, which is then wirelessly transmitted to Dynamic Location Tracker 16. Any geocode-generating device, including on-board navigation systems, should be sufficient for the purposes of the present invention provided it also has wireless transmission capacility. The timing and frequency of the dynamic location reporting process is determined by the configuration managed by Security Manager 22.

Thus, the present invention relates to a computer-implemented apparatus for dynamic event planning for a plurality of attendees comprising an event scheduler for scheduling, updating and deleting of events for the plurality of attendees; an event location finder invoked by the event scheduler for selecting at least one event location having an available timeslot for an event for the plurality of attendees; a transition requirement monitor invoked by the event scheduler for estimating the transition time from an origin location to the event location to determine if the available timeslot is feasible for the event; and a dynamic location tracker for tracking the location of the plurality of attendees and generating an event exception notice for the plurality of attendees if at least one attendee will be unable or late to attend the event at the event location at the available timeslot.

Location-aware event planning will now be discussed in more detail with particular reference to the Event Location Finder 18, Transition Requirement Monitor 20 and Dynamic Location Tracker 16. The spatial context used by these location aware features of ePLAN 10 may include the following information:
The location of attendees' offices that consist of the geocode, the room identifiers, and the postal addresses.
The location of attendees' homes that consist of both geocode and their postal addresses.
The location of event venues that consist of geocode, office or conference room identifier, and the postal addresses.
The dynamic location information of attendees during the specific time periods as configured by the privacy profile.

### The Event Location Finder

The Event Location Finder is invoked during the event scheduling process. Its task is to find, if available, the most desirable venue and time combination within the specified time period. The desirability of an event venue/time combination is based on first establishing an estimated transition cost for a potential trip an attendee might make in order to attend an event at a given location and a given time. The objective is then to select the venue/time within acceptable period such that the overall estimated transition cost for all attendees is most desirable.

### 1) The Transition Cost Notations

The notations for transition cost will now be established followed by examples of their different measurement metrics.
The ePLAN transition cost notations can be defined as follows:
To schedule for a particular event EV, let:
G={A₀, A₁, . . . , Aₙ₋₁} be the group consisting of N attendees of EV,
A_{i, 0≦i<n}, be one of N attendees,
L_{j, 0≦j<m}, be one of M available event venues, and
T_{k, 0≦k<p}, be the start time of one of P available time slots
The estimated transition cost for attendee Aᵢ to attend an event at location Lⱼ at time Tₖ is denoted as:

TC(Aᵢ, Lⱼ, Tₖ)

The overall estimated transition cost for all attendees to attend event EV at location Lⱼ at time Tₖ is:

$${TC}_{G} ( {L}_{j} , {T}_{k} ) = {\sum }_{i = 0}^{n - 1} TC ( {A}_{i} , {L}_{j} , {T}_{k} )$$

There is also defined a new relational operator “ [symbol] ” which stands for “more desirable than”.
For example, TC_{G}(Lₓ, T_{y}) [symbol] TC_{G}(Lⱼ, Tₖ) means that TC_{G}(Lₓ, T_{y}) is more desirable than TC_{G}(Lⱼ, Tₖ). More specifically, in scheduling an event EV for group G, the overall transition cost for selecting venue Lₓ at starting time T_{y} is more desirable than selecting venue Lⱼ at starting time Tₖ.
The most desirable transition cost is denoted as follows:
TC_{G}*(Lₓ, T_{y}) is most desirable such that for all L_{j, 0≦j<m}, T_{k, 0≦k<p}, and x≠j and y≠k,
TC_{G}*(Lₓ, T_{y}) [symbol] TC_{G}(Lⱼ, Tₖ)

### 2) The Origin of Transition

A transition cost is measured as an estimated cost travelling from an origin to a destination. For a particular transition cost TC(Aᵢ, Lⱼ, Tₖ) for event EV, the destination is Lⱼ. Determining the origin however is not straightforward. To attend event EV at Lⱼ, the event attendee Aᵢ may travel from home, office, hotel, or the location of another event. Taking clues from Aᵢ's calendar, ePLAN makes the following simple assumption about the origin in measuring the transition cost TC(Aᵢ, Lⱼ, Tₖ):
Step 1: If there exists another scheduled event EV′ at time Tₚ for Aᵢ, such that Tₚ precedes Tₖ in the same day and Tₖ-Tₚ (elapse time between Tₚ and Tₖ) is within a “reasonable” range (e.g., not enough time for Aᵢ to go back to office and then travel to Lⱼ), then the origin is the location of the previous event EV′.
Step 2: An electronic calendar system may integrate with a corporate travel service such that hotel and airline travel information for an employee such as Aᵢ can be programmatically obtained. In this case, during days when a hotel reservation is detected for the previous night, the location of the hotel replaces that of the home or office of the attendee.
Step 3: If Tₖ represents an early time slot during work hours, then the home of Aᵢ is the origin.
Step 4: By default, the office of Aᵢ is the origin.

### 3) Measuring Metrics of Transition Cost

The transaction cost can be measured using different metrics based on corporate policy or user preferences. In most cases, the relational operator [symbol] (more desirable than) is modeled using the < (less than) operator, such is the case of the examples of transition cost measuring metrics given below:

a. Geocode distance. With geocode available for both origin and destination, it is straightforward to calculate the direct distance between them. The metric of transition cost therefore is the geocode distance between the origin and destination calculated using the x-(latitude) and y-coordinate (longitude) values. Currently, the z-coordinate (altitude) is not modeled by ePLAN.

The geocode distance (or geo-distance) is the shortest line from one geocode to another on the surface of earth. Given the geocode of two points (lat1, long1) and (lat2, long2), then the shortest distance in miles between them in miles can be computed using the following well-known formula:

$$3956.0 \times 2 \times a sin ( min ( 1 , \sqrt{\begin{matrix}{( sin ( \frac{( lat 2 - lat 1 ) \times π}{180 \times 2} ) )}^{2} + cos ( \frac{lat 1 \times π}{180} ) \times \\ cos ( \frac{lat 2 - π}{180} ) \times {( sin ( \frac{( long 2 - long 1 ) \times π}{180 \times 2} ) )}^{2}\end{matrix}} ) )$$

The advantage of using the geocode distance as the measuring metric for computing TC_{G}*(Lₓ, T_{y}) is compute efficiency. The potential drawback is that geocode distance may not accurately correspond to the real-world costs such as travel time and money. However, it has been found empirically that geocode distance is highly correlated with estimated travel distance and time for our optimization model. Therefore, it can be an efficient alternative to querying Web-based map directions services for estimated travel distance and time.

b. Estimated travel time. The estimated travel time can be a transition cost metric so that the most desirable location/time for an event is the one with the minimum overall travel time for all attendees. There are Internet-based map directions services that provide services to compute estimated travel time. For example, the Google Maps API provides Internet-based services allowing Web applications query and present driving directions. Estimated travel time and accumulated travel mileage are part of the information returned by Web-based map directions API.

When the potential travel spans beyond driving distance, the estimated air travel time can become the metric. The estimated air travel time needs to take into consideration airport transportation, required airport check-in time, and flight time, etc. Estimating end-to-end elapse time based on air travel therefore can be difficult and inefficient.

The advantage of using estimated travel time over geocode-based distance as a transition cost metric is that the former is a more accurate metric for overall transition time. The disadvantage is that calling Internet-based maps API to request direction information can be highly inefficient if the numbers N (number of attendees), M (number of available event venues), and P (number of available time slots) are significantly large. Estimating air travel time can be very difficult and less accurate. There are potential optimizations over such inefficiency, which are presented below.

c. Estimated mileage. By using estimated mileage as the transition cost metric, Event Location Finder 18 finds the most desirable location/time for an event with the minimum overall travel mileage. The rationale may be to save fuel cost in order to conserve energy or save money. The same Web-based Map directions API mentioned above can be used to obtain the estimated mileage. The advantages and disadvantages of estimated mileage mirror those of estimated travel time.

d. Estimated travel expense. The total travel expense for an attendee travelling to an event may include many different expenses, such as car rental, meals, hotel, and airplane tickets to name a few. Many businesses have either integrated an automated travel report system or subscribe to such service hosted by external travel service providers. It is possible to extend such system/service such that based on the travel schedule an estimated total travel cost can be obtained. In this case, Event Location Finder 18 can integrate this service and compute the most desirable transition cost with the minimum estimated overall travel expense.

### 4) Extensions Beyond Simple Metrics

a. Venue clustering. The computation of the most desirable location/time for an event is directly affected by the numbers N, M, and P. Therefore its compute efficiency is in the order of O(n³). If we can reduce the number of n, then we can improve the compute efficiency linearly. The venue clustering method optimizes computation by reducing the size of M, the number of available venues.

The thinking is that for all venues in the same building or within close geographic neighborhood, the transition cost between them is negligible. Therefore all of them can be clustered and modeled by one geo-location during the computation of transition cost. Based on venue clustering, the number of locations used to compute the most desirable venue/time for an event is no longer M (e.g., the number of all available conference rooms spanning different geographic areas), but a potentially much smaller number of venue clusters (e.g., the number of buildings with available conference rooms).

b. Transition cost caching. Issuing calls to external map service API such as Google Maps API to compute the most desirable venue/time for an event can be very expensive. Since the location information for most if not all available venues (e.g., conference rooms, exhibition halls, meeting spaces) are likely to be static, it is advantageous to cache pair-wise estimated transition cost. This way, the expensive calls to external service API are only needed once for each origin-destination pair.

A maintenance program may be deployed to periodically call external maps service API for each origin-destination pair in order to update values for all cached estimated transition costs.

c. Geo-data derivation. The geocode of an event venue can be obtained by using an Internet-based maps service which converts a street address into geocode. Alternatively, the geocode of an event venue can also be obtained by mobile users with GPS-equipped mobile devices reporting to the event planning system their current location. This reporting process can be automated with the mobile client of the event planning system monitoring the mobile user's calendar and auto-reporting her current location during an event. The user may authorize the auto-reporting process, which henceforth requires no human interaction. Auto-reporting may only need to be done once, or a few time for validation, because of the static nature of venues' spatial property. It is also possible to convert geocode into street address using a service such as the geocode conversion services provided by Internet-based map services. Street addresses are the most common input for map search.

d. Empirically derived transition cost. In the discussions so far, all estimated transition costs are derived from either computation or cache retrieval of values that were previously derived from computation. A particular transition cost such as travel time between an origin and destination can be derived from actual mobile users travelling and reporting the elapse time using their mobile devices. Such reporting can be automated by the mobile client of the event planning system tracking the users' geo-locations. Thus, based on the planned events of a mobile user, the mobile client can detect her departure from the origin point and her arrival at the destination point. The mobile client can then calculate the elapse time and report back to the event planning system without the mobile user's intervention. For each origin-destination pair, the event planning system may continuously collect empirically derived transition cost, keeping a moving average while potentially throwing out outliers.

e. Transition cost with weights. It is possible to add weights to the attendee, venue and time slot in determining the most desirable venue/time for an event. For example, the event planning system may give more weight to an attendee with disability. In this case, during the computation, all estimated transition costs incurred by him to travel to various available venues will be inflated, hence carrying more weight in determining the most desirable venue/time.

Similarly, venues may carry weight or counter-weight depending on if they are a more pleasant or unpleasant place to hold the event. Time slots may also carry weight or counter-weight as there are more favorable times (e.g., sooner available time slots) as well as less favorable ones (e.g., later available time slots).

One extreme case of weighed transition cost is what is termed “selfish scheduling”. In computing selfish scheduling, all transition costs incurred by one attendee are weighed 100% while those by all other attendees are not taken into consideration. This scenario may be useful in a highly hierarchical organization which gives scheduling conveniences to the people on top, e.g., the president, CEO, and generals.

f. A case for different operator. In the discussion above, the relational operator [symbol] (more desirable than) is modeled using the < (less than) operator. The computation always searches for the overall shortest geocode distance, shortest time, least mileage, or least travel cost.

In some cases, it is possible to model the relational operator [symbol] (more desirable than) with a different operator. For example, in an organization situated inside a large building (or on a campus with close-by buildings for that matter), Event Location Finder 18 may use the geocode distance as the estimated transition cost metric and use the > (more than) operator to model the [symbol] (more desirable than) operator. In this case, Event Location Finder 18 seeks to find the most desirable venue/time for an event that has the maximum accumulated geocode distance for overall transition costs among all attendees. The effect across time is that people need to walk more into order to go to meetings and other events. It can be a way for a business to keep its employees healthy, thereby reducing the medical insurance cost.

### The Transition Requirement Monitor

Present electronic calendar systems do not take into account the transition requirements incurred by an event for each of its attendees. For example, it may take 15 minutes for an attendee to travel from her office to attend a scheduled event. The present electronic calendar systems only associate time periods with scheduled events, not the transition to an event. The transition time an attendee travels to attend a scheduled meeting is treated by the system as open. In modern enterprise electronic calendar systems, authorized employees are allowed to inspect the calendars of their colleagues for available time slots. Being unaware of the transition time, the system displays all open time slots which are allowed by authorized users to schedule events, even if some open slots overlap with some attendees being in transition. It is up to each attendee to be mindful of her own transition requirement and determine if an event scheduling request is feasible. A typical scenario in scheduling a multi-attendee event therefore involves sending event request/denial emails back and forth among attendees before they settle the time.

The Transition Requirement Monitor 20 of ePLAN 10 addresses this issue by dynamically computing an estimated transition time for an event to ensure that the time slots selected during the scheduling process satisfy the transition requirement. The Event Location Finder 18 requests the service of Transition Requirement Monitor 20 by way of Event Scheduler 12 that serves as the communication center.

Specifically, before Event Location Finder 18 computes each TC(Ai, Lj, Tk) during the computation of the most desirable venue/time for event EV, the Event Location Finder 18 requests Event Scheduler 12 to invoke Transition Requirement Monitor 20 in making sure TC(Aᵢ, Lⱼ, Tₖ) satisfies the transition requirement. The Transition Requirement Monitor 20 performs the following checking process:
Determine the origin of transition Lₒ for TC(Aᵢ, Lⱼ, Tₖ). This is achieved by the steps presented above.
Compute the estimated travel time TT from Lₒ to Lⱼ. In order for attendee Aᵢ to attend the event EV, the latest estimated starting time for attendee Aᵢ to transition to Lⱼ from Lₒ in order to arrive by Tₖ is (Tₖ-TT). Here (Tₖ-TT) stands for a point in time that is TT earlier than T_{k.}
If the time period from (Tₖ-TT) to Tₖ overlaps with any other scheduled event(s), TC(Aᵢ, Lⱼ, Tₖ) fails the transition requirement.
If the time period from (Tₖ-TT) to Tₖ does not overlap with any other scheduled event(s), TC(Aᵢ, Lⱼ, Tₖ) satisfies the transition requirement. The state of the time slots covering the period from (Tₖ-TT) to T_{k i} is updated as in transition.

The Transition Requirement Monitor 20 and Event Location Finder 18 share the same computation that determine the origin O for TC(Aᵢ, Lⱼ, Tₖ). They also share the same computing of TC(Aᵢ, Lⱼ, Tₖ) if the transition cost measuring metric used by Event Location Finder 18 is estimated travel time. The Transition Requirement Monitor 20 adds an additional state for time slots, namely the state of in transition. This new state can be used by the electronic calendar system to mark time slots with the in transition status to prevent them from being scheduled for new events.

### The Dynamic Location Tracker

The Dynamic Location Tracker 16 keeps track of the current location of attendees during some pre-specified periods of time. If Dynamic Location Tracker 16 determines that the current location of an attendee will not likely make the next event on time, it sends a notice to notify other attendees of this event accordingly.

### 1) Tracking the Users

Users with GPS-equipped mobile devices can register to periodically report their location to Dynamic Location Tracker 16. This is made possible by a mobile client that runs in the background in the mobile device. The mobile client wakes up periodically and uses device-based location API to obtain its current location. The current location, in the format of geocode, is transmitted to Dynamic Location Tracker 16 through a wireless cellular network.

### 2) Checking for Potential Transition Problems

Upon receiving the current location for a user such as Aᵢ, Dynamic Location Tracker 16 retrieves her scheduled events (e.g., the event EV) held currently or in the near future. It then computes the estimated travel time TT from Aᵢ's current location to the locations of the coming events, say Lⱼ. It may use external maps direction services to compute estimated travel time. Alternatively, it may simply use geocode distance to predict the estimated travel time.

Let LAT (Late Arrival Time) be a predefined time that any period longer than LAT is considered late (e.g., LAT=5 minutes is a reasonable setting), and NST (No-Show Time) be another predefined time interval that any period longer than NST is considered a no-show (e.g., NST=20 might be considered a reasonable setting), then the condition

NST≧TT−(Tₖ−T_{curr})>LAT

incurs a late-arrival exception by Aᵢ for event EV, whereas the condition

TT−(Tₖ−T_{curr})>NST

incurs a no-show exception by Aᵢ for event EV.

### 3) Sending Notifications

When a late-arrival or no-show exception by Aᵢ for event EV occurs, Dynamic Location Tracker 16 may send a notification to attendees of EV with a proper message. In ePLAN 10 the actual notification process is achieved by the Notifier 24. The actual technology used for transporting the exception notices is implementation specific. Examples of notification technology, for purposes of illustration and not limitation, include SMS, automated voice messages, email, or their combinations.

### 4) Managing Privacy

Privacy is protected by Security Manager 22, which manages the privacy base to protect the privacy of the users. In privacy base, users specify their own privacy requirements through rules. In particular, each user is able to specify when her dynamic location can be disclosed (e.g. only during work time), where her location can be disclosed (e.g. only in the company area), and to whom her location can be disclosed (e.g. only to the server, some users, or all users).

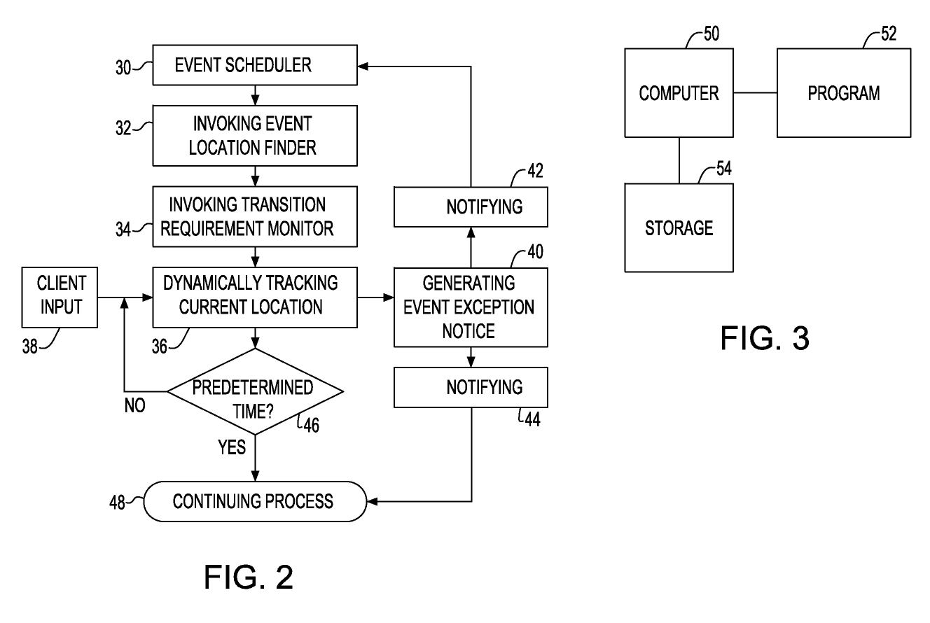

Referring now to FIG. 2, there is shown a computer-implemented method for practicing the current invention of dynamic event planning for a plurality of attendees. The first step is obtaining an event scheduler to schedule, update and delete events for the plurality of attendees as indicated in block 30. Next, invoking an event location finder by the event scheduler to select at least one event location having an available timeslot for an event for the plurality of attendees as indicated by block 32. In the next step as indicated in block 34, there is invoking a transition requirement monitor by the event scheduler to estimate the transition time from an origin location to the event location to determine if the available timeslot is feasible for the event. The method continues by dynamically tracking the current location of the plurality of attendees, block 36. Client input (block 38) from geocode generating devices, such as a GPS device in a PDA, is used for dynamically tracking the current location of the plurality of attendees. If during dynamically tracking, all attendees will be able to attend the scheduled event, on time and at the scheduled location, then the process continues to dynamically track the current location of the attendees until a predetermined time is reached, block 46. The predetermined time could be the scheduled start time or some time beforehand (e.g., 30 minutes before the scheduled start time), after which no further changes to the schedule can be made. Once the predetermined time as been reached, the process continues, as indicated by block 48, to address future events. Referring back to block 36, if during the step of dynamically tracking, it is determined that an attendee will be late or unable to attend the event at the event location at the available timeslot, the process proceeds to generating an event exception notice for the plurality of attendees, block 40. According to predetermined rules, the process may continue by notifying the attendees, block 42, that the event will be rescheduled and the process proceeds back to the event scheduler, block 30, to reschedule the event. Alternatively, the process could continue by notifying the attendees, block 44, that an attendee (perhaps an unimportant attendee) will be unable or late to attend but the event will still be held at the scheduled location and time.

A further step of the method could include, in the step of selecting at least one event location, estimating a transition cost for an attendee to attend the event at the event location at the available timeslot. The transition cost could include at least one of a geocode distance from the origin location to the event location, an estimated travel time from the origin location to the event location, an estimated mileage from the origin location to the event location, and an estimated travel expense to travel to the event location from the origin location. Estimating a transition cost could include estimating an overall transition cost for the plurality of attendees to attend the event at the event location at the available timeslot and the step of selecting includes selecting the event location and available timeslot having the lowest overall transition cost.

The user interface of ePLAN is implemented using PHP and MySQL database for maximum portability. The main focus of ePLAN is on optimization of overall transaction cost, for which the algorithms of Event Location Finder, Transition Requirement Monitor, and Dynamic Location Tracker are implemented using the Java Language. The existing prototype may be installed on a Windows XP server using the Web application system platform provided by open source community such as Apache.

The location aware event planning system ePLAN models events with both temporal and spatial contexts. The present invention incorporates the spatial information to provide innovative approaches to help users schedule, keep track, and cope with dynamic changes to calendar events more efficiently.

FIG. 3 is a block diagram that illustrates an exemplary hardware environment of the present invention. The present invention is typically implemented using a computer 50 comprised of microprocessor means, random access memory (RAM), read-only memory (ROM) and other components. The computer may be a personal computer, mainframe computer or other computing device. Resident in the computer 50, or peripheral to it, will be a storage device 54 of some type such as a hard disk drive, floppy disk drive, CD-ROM drive, tape drive or other storage device.

Generally speaking, the software implementation of the present invention, program 52 in FIG. 3, is tangibly embodied in a computer-readable medium such as one of the storage devices 54 mentioned above. The program 52 comprises instructions which, when read and executed by the microprocessor of the computer 50 causes the computer 50 to perform the steps necessary to execute the steps or elements of the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be apparent to those skilled in the art having regard to this disclosure that other modifications of this invention beyond those embodiments specifically described here may be made without departing from the spirit of the invention. Accordingly, such modifications are considered within the scope of the invention as limited solely by the appended claims.

We claim:

1. A computer-implemented apparatus for dynamic event planning for a plurality of attendees comprising:
an event location finder to select at least one event location having an available timeslot for an event for the plurality of attendees;
a transition requirement monitor to estimate a transition time from an origin location to the event location to determine if the available timeslot is feasible for the event; and
a dynamic location tracker to track a location of the plurality of attendees and provide an event exception notice to the plurality of attendees if at least one attendee will be unable or late to attend the event at the event location at the available timeslot.

2. The apparatus of claim 1 wherein the event location finder further includes to estimate a transition cost for an attendee to attend the event at the event location at the available timeslot.

3. The apparatus of claim 2 wherein the transition cost includes at least one of a geocode distance from the origin location to the event location, an estimated travel time from the origin location to the event location, an estimated mileage from the origin location to the event location, and an estimated travel expense to travel to the event location from the origin location.

4. The apparatus of claim 2 wherein an overall transition cost is estimated for the plurality of attendees to attend the event at the event location at the available timeslot and the event location finder selects the event location and available timeslot having the lowest overall transition cost.

5. The apparatus of claim 1 wherein the dynamic location tracker keeps track of a current location of the plurality of attendees for a predetermined period of time, determines if any of the plurality of attendees likely will be unable or late to attend the event at the event location at the available timeslot given the current location of the plurality of attendees and notifies by an event exception notice the plurality of attendees if at least one attendee will be unable or late to attend the event at the event location at the available timeslot.

6. The apparatus of claim 1 wherein the event is rescheduled in response to the event exception notice.

7. A computer-implemented apparatus for dynamic event planning for a plurality of attendees comprising:
an event scheduler to schedule, update and delete events for the plurality of attendees;
an event location finder invoked by the event scheduler to select at least one event location having an available timeslot for an event for the plurality of attendees;
a transition requirement monitor invoked by the event scheduler to estimate a transition time from an origin location to the event location to determine if the available timeslot is feasible for the event; and
a dynamic location tracker to track a location of the plurality of attendees and generate an event exception notice for the plurality of attendees if at least one attendee will be unable or late to attend the event at the event location at the available timeslot.

8. The apparatus of claim 7 wherein the event exception notice is provided to the event scheduler and further comprising a notifier to receive the event exception notice from the event scheduler and provide the event exception notice to the plurality of attendees.

9. The apparatus of claim 7 wherein the event location finder further includes to estimate a transition cost for an attendee to attend the event at the event location at the available timeslot.

10. The apparatus of claim 9 wherein the transition cost includes at least one of a geocode distance from the origin location to the event location, an estimated travel time from the origin location to the event location, an estimated mileage from the origin location to the event location, and an estimated travel expense to travel to the event location from the origin location.

11. The apparatus of claim 9 wherein an overall transition cost is estimated for the plurality of attendees to attend the event at the event location at the available timeslot and the event location finder selects the event location and available timeslot having the lowest overall transition cost.

12. The apparatus of claim 7 wherein the dynamic location tracker keeps track of a current location of the plurality of attendees for a predetermined period of time, determines if any of the plurality of attendees likely will be unable or late to attend the event at the event location at the available timeslot given the current location of the plurality of attendees and generates an event exception notice to the event scheduler if at least one attendee will be unable or late to attend the event at the event location at the available timeslot.

13. The apparatus of claim 7 wherein the event is dynamically rescheduled by the event scheduler in response to the event exception notice.

14. A computer-implemented method for dynamic event planning for a plurality of attendees, the method comprising the steps of:
selecting at least one event location having an available timeslot for an event for the plurality of attendees;
estimating a transition time from an origin location to the event location to determine if the available timeslot is feasible for the event; and
dynamically tracking a current location of the plurality of attendees and providing an event exception notice to the plurality of attendees if at least one attendee will be unable or late to attend the event at the event location at the available timeslot.

15. The method of claim 14 wherein selecting at least one event location further includes estimating a transition cost for an attendee to attend the event at the event location at the available timeslot.

16. The method of claim 15 wherein the transition cost includes at least one of a geocode distance from the origin location to the event location, an estimated travel time from the origin location to the event location, an estimated mileage from the origin location to the event location, and an estimated travel expense to travel to the event location from the origin location.

17. The method of claim 14 wherein the step of estimating a transition cost includes estimating an overall transition cost for the plurality of attendees to attend the event at the event location at the available timeslot and the step of selecting includes selecting the event location and available timeslot having the lowest overall transition cost.

18. The method of claim 14 wherein the step of dynamically tracking includes tracking a current location of the plurality of attendees for a predetermined period of time, determining if any of the plurality of attendees likely will be unable or late to attend the event at the event location at the available timeslot given the current location of the plurality of attendees and notifying by an event exception notice the plurality of attendees if at least one attendee will be unable or late to attend the event at the event location at the available timeslot.

19. The method of claim 14 further comprising the step of rescheduling the event in response to the event exception notice.

20. A computer-implemented method for dynamic event planning for a plurality of attendees comprising:
obtaining an event scheduler to schedule, update and delete events for the plurality of attendees;
invoking an event location finder by the event scheduler to select at least one event location having an available timeslot for an event for the plurality of attendees;
invoking a transition requirement monitor by the event scheduler to estimate a transition time from an origin location to the event location to determine if the available timeslot is feasible for the event; and
dynamically tracking a current location of the plurality of attendees and generating an event exception notice for the plurality of attendees if at least one attendee will be unable or late to attend the event at the event location at the available timeslot.

21. The method of claim 20 wherein invoking an event location finder by the event scheduler for selecting at least one event location includes estimating a transition cost for an attendee to attend the event at the event location at the available timeslot.

22. A computer program product for dynamic event planning for a plurality of attendees, the computer program product comprising:
a computer readable storage medium having computer readable program code embodied therewith, the computer readable program code comprising:
computer readable program code configured to select at least one event location having an available timeslot for an event for the plurality of attendees;
computer readable program code configured to estimate a transition time from an origin location to the event location to determine if the available timeslot is feasible for the event; and
computer readable program code configured to dynamically track a current location of the plurality of attendees and provide an event exception notice to the plurality of attendees if at least one attendee will be unable or late to attend the event at the event location at the available timeslot.

23. The computer program product of claim 22 wherein the computer readable program code configured to select at least one event location further includes computer readable program code configured to estimate a transition cost for an attendee to attend the event at the event location at the available timeslot.

24. The computer program product of claim 23 wherein the computer readable program code configured to estimate a transition cost includes computer readable program code configured to estimate an overall transition cost for the plurality of attendees to attend the event at the event location at the available timeslot and the computer readable program code configured to select includes computer readable program code configured to select the event location and available timeslot having the lowest overall transition cost.

25. The computer program product of claim 22 wherein the computer readable program code configured to dynamically track includes computer readable program code configured to track a current location of the plurality of attendees for a predetermined period of time, computer readable program code configured to determine if any of the plurality of attendees likely will be unable or late to attend the event at the event location at the available timeslot given the current location of the plurality of attendees and computer readable program code configured to notify by an event exception notice the plurality of attendees if at least one attendee will be unable or late to attend the event at the event location at the available timeslot.
